(19) United States
(12) Patent Application Publication
(10) Pub. No.: US 2003/0059366 A1
(43) Pub. Date: Mar. 27, 2003

(54) Dispersible barium titanate-based particles and methods of forming the same

(75) Inventors: Sridhar Venigalla, Macungie, PA (US); Jeffrey A. Kerchner, Fleetwood, PA (US)

Correspondence Address: Martha Ann Finnegan, Cabot Corporation, 157 Concord Road, Billerica, MA, 01821, US

(73) Assignee: Cabot Corporation, Billerica, MA

(21) Appl. No.: 10/244,828

(22) Filed: Sep. 16, 2002

Related U.S. Application Data
(60) Provisional application No. 60/323,946, filed on Sep. 21, 2001.

(51) Int. Cl. C01G 23/04

(52) U.S. Cl. 423/598; 423/275

(57) ABSTRACT

Dispersible barium titanate-based particles and methods of forming the same are provided. One method involves subjecting the barium titanate-based particles to a heating step which removes hydroxyl groups from particle surfaces. Another method involves attaching a coupling agent to surfaces of the barium titanate-based particles. Both methods reduce the tendency of particles to agglomerate and/or aggregate when subsequently dispersed in a fluid. Thus, the methods enable production of dispersions that have a relatively uniform distribution of particles throughout. Such dispersions may be further processed as desired to form, for example, dielectric layers, polymer/dielectric composites or other structures. The structure may also include a uniform distribution of barium titanate-based particles which can improve properties amongst other advantages.

### RELATED APPLICATIONS

This application claims priority under 35 U.S.C. §119(e) to U.S. Provisional Application Serial No. 60/323,946, entitled “Dispersible Barium Titanate-Based Particles and Methods of Forming the Same,” filed on Sep. 21, 2001, which is herein incorporated by reference in its entirety.

### FIELD OF INVENTION

The invention relates generally to dielectric compositions and, more particularly, to dispersible barium titanate-based particles and methods of forming the same.

### BACKGROUND OF INVENTION

Barium titanate-based compositions, which include barium titanate (BaTiO₃) and its solid solutions, may be used as dielectric materials in electronic devices. The barium titanate-based compositions are typically produced as small particles which are further processed to form the desired structure. In some cases, the particles are further processed to form a sintered dielectric layer, for example, within a multi-layer ceramic capacitor (MLCC). In other cases, the particles are dispersed in a polymer matrix to form a composite. Such composites are suitable for use as a dielectric layer, for example, in embedded capacitor applications.

During processing, barium titanate-based particles are oftentimes dispersed in a fluid to form a dispersion. Such dispersions can be cast and, then, heated to evaporate the fluid thereby forming a layer. For example, to form a polymer/dielectric composite layer, the particles are dispersed in a solvent in which polymeric material is dissolved. The dispersion is cast and heated to evaporate the solvent thereby forming a composite structure in which the barium titanate-based particles are distributed throughout a polymer matrix.

In some processes it is advantageous to uniformly disperse the barium titanate-based particles in the fluid so that the resulting material has the particles uniformly distributed therein. For example, in certain polymer/dielectric composite applications, it is desirable for the particles to be relatively uniformly distributed throughout the polymer matrix to provide relatively consistent electrical properties across the composite and to enable formation of thin composite layers. However, particles in the dispersion may agglomerate and/or aggregate due to electrostatic attraction therebetween. Such agglomeration and/or aggregation can limit the uniformity of a dispersion and, thus, the material produced from the dispersion.

One conventional technique for increasing dispersibility of particles in a dispersion involves adding a coupling agent directly to the dispersion. Mixing and milling techniques are also conventionally used to increase the dispersibility of particles in a dispersion.

### SUMMARY OF INVENTION

The invention provides dispersible barium titanate-based particles and methods of forming the same.

In one aspect, a method of processing barium titanate-based particles is provided. The method includes providing a mixture comprising barium titanate-based particles, a coupling agent, and a first fluid. The method further includes removing the fluid to form a barium titanate-based particle composition, wherein the coupling agent is attached to surfaces of at least a portion of the barium titanate-based particles. The method further includes dispersing the barium titanate-based particle composition in a second fluid to form a dispersion.

In another aspect, a method of processing barium titanate-based particles is provided. The method includes removing hydroxyl groups from surfaces of the barium titanate-based particles by heating the barium titanate-based particles to a maximum temperature of greater than about 300° C. and less than about 500° C.

In another aspect, a particulate composition including a plurality of dried barium titanate-based particles is provided. A coupling agent is attached to surfaces of at least a portion of the barium titanate-based particles.

Other aspects and features of the invention will become apparent from the following detailed description. All references incorporated herein are incorporated in their entirety. In cases of conflict between an incorporated reference and the present specification, the present specification shall control.

### BRIEF DESCRIPTION OF DRAWINGS

FIG. 1 is a graph of shear strength versus shear rate for the dispersions produced in Example 1.

### DETAILED DESCRIPTION

Dispersible barium titanate-based particles and methods of forming the same are provided. One method involves subjecting the barium titanate-based particles to a heating step which removes hydroxyl groups from particle surfaces. Another method involves attaching a coupling agent to surfaces of the barium titanate-based particles. As described further below, both methods reduce the tendency of particles to agglomerate and/or aggregate when subsequently dispersed in a fluid. Thus, the methods enable production of dispersions that have a relatively uniform distribution of particles throughout. Such dispersions may be further processed as desired to form, for example, dielectric layers, polymer/dielectric composites or other structures. The structures can include a uniform distribution of barium titanate-based particles which can improve properties amongst other advantages.

The barium titanate-based particles may be produced according to any technique known in the art including hydrothermal processes, solid-state reaction processes, sol-gel processes, as well as precipitation and subsequent calcination processes, such as oxalate-based processes. The methods of the present invention for enhancing dispersibility may be particularly useful for particles produced using hydrothermal processes. Hydrothermal processes generally involve mixing a barium source with a titanium source in an aqueous environment to form a hydrothermal reaction mixture which is maintained at an elevated temperature to promote the formation of barium titanate particles. When forming barium titanate solid solution particles hydrothermally, sources including the appropriate divalent or tetravalent metal may also be added to the hydrothermal reaction mixture. Suitable hydrothermal processes for forming barium titanate-based particles have been described, for example, in commonly-owned U.S. Pat. Nos. 4,829,033, 4,832,939, and 4,863,883, which are incorporated herein by reference in their entireties.

As used herein, “barium titanate-based particles” refers to particles having the composition of barium titanate, solid solutions thereof, or other oxides based on barium and titanium having the general structure ABO₃, where A represents one or more divalent metals such as barium, calcium, lead, strontium, magnesium and zinc and B represents one or more tetravalent metals such as titanium, tin, zirconium, and hafnium. One type of barium titanate-based particulate composition has the structure Ba₍₁₋ₓ₎AₓTi(_{1-y})B_{y}O₃, where x and y can be in the range of 0 to 1, where A represents one or more divalent metal other than barium such as lead, calcium, strontium, magnesium and zinc and B represents one or more tetravalent metals other than titanium such as tin, zirconium and hafnium. Where the divalent or tetravalent metals are present as impurities, the value of x and y may be small, for example less than 0.1. In other cases, the divalent or tetravalent metals may be introduced at higher levels to provide a significantly identifiable compound such as barium-calcium titanate, barium-strontium titanate, barium titanate-zirconate, and the like. In still other cases, where x or y is 1.0, barium or titanium may be completely replaced by the alternative metal of appropriate valence to provide a compound such as lead titanate or barium zirconate. In other cases, the compound may have multiple partial substitutions of barium or titanium. An example of such a multiple partial substituted composition is represented by the structural formula Ba_{(1-x-x′-x″)} PbₓCa_{x′}Sr_{x″}O.Ti_{(1-y-y′-y″)} Sn_{y}Zr_{y′}Hf_{y″}O₂, where x, x′, x″, y, y′, and y″ are each greater than or equal to 0. In many cases, the barium titanate-based material will have a perovskite crystal structure, though in other cases it may not.

The barium titanate-based particles may have a variety of different characteristics. In some cases, the barium titanate-based particles have an average particle size of less than about 0.5 micron; and, in some cases, the average particle size is about 0.1 micron or less. As used herein, the term “average particle size” refers to the average size of primary particles in the composition. The average particle size of a composition may be determined using SEM analysis or other suitable techniques. The barium titanate-based particles, in some cases, have a uniform particle size and, thus, a small particle size distribution.

The barium titanate-based particles may also have a variety of shapes which may depend, in part, upon the process used to produce the particles. In some cases, the barium titanate-based particles may be substantially equiaxed and/or substantially spherical. Substantially spherical barium titanate-based particles may be particularly useful in composite applications because the spherical shape increases the weight percentage of particles that can be distributed throughout a matrix. Hydrothermal processes, for example, can be used to produce substantially spherical particles. In other cases, the barium titanate-based particles have an irregular, non-equiaxed shape. Such irregular particles typically result from a milling step that is utilized during their production.

The barium titanate-based particulate composition may include a mixture of more than one type of barium titanate-based particle. The particles in the mixture may include any of the characteristics (e.g., size, shapes or composition) described herein. Also, the barium titanate-based particles may be mixed with other components such as dopant metal compounds. Dopant metal compounds, such as oxides or hydroxides, can be provided to enhance certain electrical or mechanical properties. Examples of dopant metals include, but are not limited to, lithium, magnesium, molybdenum, tungsten, scandium, vanadium, niobium, tantalum, manganese, cobalt, nickel, zinc, boron, silicon, antimony, yttrium, lanthanum, lead, bismuth or Lanthanide elements. In some embodiments, the dopant metal compounds may be coated onto surfaces of the barium titanate-based particles. Suitable coated particles and processes to form the same have been described, for example, in commonly-owned U.S. Pat. No. 6,268,054, which is incorporated herein by reference in its entirety.

As described above, the barium titanate-based particles are treated according to methods of the invention to increase their dispersibility.

One method involves heating the barium titanate-based particles to remove hydroxyl groups (i.e., OH⁻groups) from particle surfaces. The hydroxyl groups may be ionic species, or may be part of a compound (e.g., H₂O). The hydroxyl groups may be chemically, physically, or otherwise attached or associated with the particle surfaces. In particular, barium titanate-based particles that are produced using a hydrothermal process and conventionally dried generally have hydroxyl groups attached to their surfaces. Thus, such barium titanate-based particles are particularly well-suited to be treated using this heating method. In some cases, hydroxyl groups resulting from hydrothermal processing comprise between about 1% and about 2% of the total weight of the particulate composition. It is to be understood, however, that barium titanate-based particles produced using other processes may also have hydroxyl groups attached to their surfaces and can be treated using the heating method.

The hydroxyl groups are removed by heating the particles to a sufficient temperature and for a sufficient time so as to cause the hydroxyl groups to detach from particles surfaces. The specific heating conditions may depend upon characteristics of the particulate composition including composition size and particle size amongst others. Conventional drying temperatures (e.g., 200° C. or less) have been found to be too low to sufficiently remove hydroxyl groups from particle surfaces. The heating step is generally carried out at temperatures and times that are insufficient to cause substantial particle growth and insufficient to cause particle sintering. In one set of embodiments, the particles are heated to a maximum temperature of greater than about 300° C. and less than about 500° C. to remove the hydroxyl groups. In some embodiments, the maximum temperature is between about 350° C. and about 450° C. (e.g., about 400° C.). It may be desirable to maintain the particulate composition at a relatively constant temperature between about 300° C. and about 500° C. for a dwell period. Though in other cases, the particulate composition is heated to the maximum temperature within this range but then cooled without the dwell period.

Heating time generally depends on the size of the particulate composition and can be readily determined by one of ordinary skill in the art. Any suitable heating system (e.g., furnace, vacuum furnace) can be used to heat the particles. After heating the particles are cooled, generally to room temperature.

When barium titanate-based particles are produced hydrothermally, the particles remain in an aqueous fluid after formation. Prior to the heating step, the particles are filtered to eliminate excess water (e.g., using a filter press) thereby forming a wet cake which includes about 80% by weight particles and about 20% by weight water. The wet cake may be directly subjected to the heating step. In other cases, an intermediate drying step may take place prior to the heating step. Any conventional drying technique may be used in this intermediate step. For example, the composition may be heated to conventional drying temperatures (e.g., between about 50° C. and about 200° C.), freeze dried, spray dried, or dried in a fluidized-bed.

In another set of embodiments, the present invention involves treating barium titanate-based particles using a coupling agent method to improve particle dispersibility. This coupling agent method may be used in connection with the above-described heating method, or may be used without the heating method. When used in connection with the heating method, the coupling agent method generally is carried out after the heating method.

The coupling agent method involves forming a mixture of barium titanate-based particles, a coupling agent and a fluid according to one embodiment. The coupling agent attaches to surfaces of the barium titanate-based particles. Typically, the attachment is due to electrostatic attractive forces between the coupling agent and the particles. Any of the barium titanate-based particles described herein may be used, though this method is particularly useful in enhancing the dispersibility of hydrothermally-produced barium titanate-based particles.

The composition of the fluid is selected so as to promote attachment of the coupling agent to particle surfaces. In some embodiments, the fluid is alcohol-based. In some cases, alcohol-based solutions have a large percentage of alcohol (e.g., greater than about 90% by weight) and a small percentage of water (e.g., less than about 10% by weight). A number of different alcohol-based solutions may be used. One exemplary solution includes about 95% weight ethanol and about 5% by weight water. It should be understood that other fluids that promote attachment of the coupling agent to particle surfaces may also be used.

In some cases, the pH of the fluid is adjusted to a value that increases electrostatic attractive forces between the coupling agent and particle surfaces. To achieve such a condition, the pH is generally lowered by adding a suitable acid (e.g., nitric acid). The specific value that the pH is lowered depends in part upon process parameters such as the type of fluid and coupling agent used. A pH condition of about 4 has been found to be effective for non-aqueous fluids and silane-based coupling agents. Generally, the barium titanate-based particles are added to the solution and the pH is adjusted (if required) prior to the addition of the coupling agent. However, other orders of operation can also be used. Throughout the method, the mixture may be stirred to ensure homogenous distribution of the particles, coupling agent, and pH adjusting agent (if added).

Suitable coupling agents are compounds that include a first hydrophilic portion that is attracted to barium titanate-based particle surfaces and a second hydrophobic portion that is attracted to fluid molecules. Examples of suitable coupling agents include, but are not limited to, silane-based coupling agents. Examples of silane-based coupling agents include n-octyletriethoxysilane, dodecyltriethoxysilane, octadecyltriethoxysilane, n-aminohexyl-aminopropyltrimethoxysilane, aminopropyltriethoxysilane, trimethoxysilylpropyldiethylenetriamine, n-phenylaminopropyltrimethoxysilane, epoxycycloxehylethyl trimethoxysilane, glycidoxypropyl trimethoxysilane, epoxypropyl trimethoxysilane, and mercaptopropyl trimethoxysilane, amongst others. It should be understood that other suitable coupling agents known in the art can also be used.

The coupling agent is added in an amount sufficient to obtain the desired particle dispersibility. To optimize particle dispersibility, it is generally desirable to add the coupling agent in an amount that is sufficient to attach to surfaces of substantially all (or the majority) of the particles. However, if too much coupling agent is added then unattached coupling agent molecules can reduce dispersibility. The amount of coupling agent added depends upon the particular process and particle characteristics (e.g., particle size). In some cases, the coupling agent is added in an amount that is between about 0.5% and about 10% of the total weight of the barium titanate-based particles (when dried). In some cases, the coupling agent is added in an amount that is between about 1% and about 5% of the total weight of the barium titanate-based particles (when dried).

After the coupling agent attaches to barium titanate-based particle surfaces, the mixture is filtered. In some cases, though not all, the particles are washed with ethanol to remove excess nitrates. The filtered particles may then be dried at a suitable temperature (e.g., at about 70° C.). In other cases, the particles may not be dried, but only filtered. In either case, the resulting particulate composition includes barium titanate-based particles have a coupling agent attached thereto.

As described above, the dispersibility of the barium titanate-based particles that are treated according to the methods described herein is increased. The dispersibility is increased when the particles are dispersed in a fluid, for example, in a subsequent processing step. In particular, particle dispersibility is increased when the particles are dispersed in non-aqueous fluids. Such non-aqueous fluids can include any of the type used in barium titanate-based particle processing. It should also be understood that particle dispersibility, in some cases, may be increased when the particles are dispersed in aqueous fluids.

The dispersibility of particles that are heated to remove hydroxyl groups is increased because the absence of the hydroxyl groups reduces attractive electrostatic charges between particles that may arise when the particles are dispersed. Similarly, the dispersibility of particles having coupling agent attached thereto is increased because the coupling agent reduces attractive electrostatic charges between particles that may arise when the particles are dispersed. It is observed that the method of the present invention of attaching the coupling agent to particle surfaces, then drying, and dispersing the particles having the coupling agent attached thereto can provide improved dispersibility over conventional dispersing techniques in which the coupling agent is separately added to a dispersion of particles. It is believed that this improvement over the conventional technique is a result of the strong attractive forces between the particles and the coupling agent that result from this method of the present invention.

The dispersible barium titanate-based particles are useful in any process that includes a step of dispersing barium titanate-based particles in a fluid for further processing. Such processes, for example, can involve forming a dispersion including the particles, casting the dispersion, and forming a layer. Examples include processes that form dielectric layers in an electronic device (e.g., MLCC) and processes that form polymer/dielectric composite layers. The enhanced dispersibility can reduce particle agglomeration and/or aggregation in the dispersion and can increases the uniformity of particle distribution throughout the dispersion. Thus, layers formed from such dispersions typically have a relatively uniform distribution of particles therethrough. The uniform distribution of particles can lead to consistent properties across the layer and, in some cases, can enable production of thinner layers which may be important in certain applications.

As described above, the barium titanate-based particles may be dispersed in a fluid and further processed to form a polymer/dielectric composite. One exemplary technique of forming a polymer/dielectric composite involves dispersing the barium titanate-based particles (after being treated to increase their dispersibility) in a non-aqueous solvent in which a polymeric matrix precursor is dissolved. The selection of solvent and polymeric matrix precursor depends upon the application. Suitable polymeric materials include epoxies, polyamides, and polyimides, amongst others. One suitable solvent (for epoxies, polyamides, and polyimides) is NMP (1-methyl, 2 pyrrolidnone), though it should be understood that a variety of other solvents may also be used. The dispersion is cast to form a layer which is heated to evaporate the solvent. The resulting composite structure includes the barium titanate-based particles distributed uniformly throughout a polymer matrix. Such structures are particularly suitable for use in embedded capacitor applications.

Although it is described herein that the barium titanate-based particles can be processed to form dielectric layers in electronic devices (e.g., MLCCs) and polymer/dielectric composites (e.g., for use in embedded capacitor applications), it should be understood that the particles may be further processed to produce any desired structure.

The present invention will be further illustrated by the following example, which is intended to be illustrative in nature and is not to be considered as limiting the scope of the invention.

### EXAMPLE

Conventional methods of dispersing barium titanate-based particles are compared to a method of the present invention.

Barium titanate (BaTiO₃) particles were produced in a hydrothermal process. Six samples were made, each of which included 65 g of the barium titanate particles.

Sample 1 was added to about 35 g of NMP (1-methyl, 2 pyrrolidnone), a solvent, to provide a mixture that included about 65 percent by weight of the barium titanate particles. No coupling agent was added to the mixture. The mixture was mixed with a high shear mixer to provide dispersion 1. This technique is representative of a conventional method of dispersing particles without the addition of a coupling agent.

Sample 2 was added to about 35 g of NMP (1-methyl, 2 pyrrolidnone) to provide a mixture that included about 65 percent by weight of the barium titanate particles. About 2.6 g (4 percent of the total weight of the particles) of glycidoxypropyltrimethoxysilane, a silane-based coupling agent, was added to the mixture. The mixture was mixed with a high shear mixer to provide dispersion 2. This technique is representative of a conventional method of dispersing particles by separately adding a coupling agent to a mixture of particles and fluid, and then dispersing the particles.

Sample 3 was added to a mixture of ethanol (95 weight percent) and water (5 weight percent). Nitric acid was added to the mixture to reduce the pH to about 4. About 1.30 g (2 percent of the total weight of the particles) of glycidoxypropyltrimethoxysilane was added to the mixture. The mixture was mixed with a high shear mixer. After approximately one minute, the particles were filtered and dried to provide particles that had glycidoxypropyltrimethoxysilane attached to their surfaces. The particles were added to about 35 g of NMP (1-methyl, 2 pyrrolidnone) to provide a mixture that included about 65 percent by weight of the barium titanate particles. The mixture was mixed with a high shear mixer to provide dispersion 3. This technique is representative of a method of the present invention of dispersing particles.

Samples 4-6 were processed in a similar manner as sample 3 except the amount of glycidoxypropyltrimethoxysilane added to the mixture was varied. Sample 4 was processed with about 1.95 g (3 percent of the total weight of the particles) of glycidoxypropyltrimethoxysilane. Dispersion 4 was produced from sample 4. Sample 5 was processed with about 2.60 g (4 percent of the total weight of the particles) of glycidoxypropyltrimethoxysilane. Dispersion 5 was produced from sample 5. Sample 6 was processed with about 3.25 g (5 percent of the total weight of the particles) of glycidoxypropyltrimethoxysilane. Dispersion 6 was produced from sample 6.

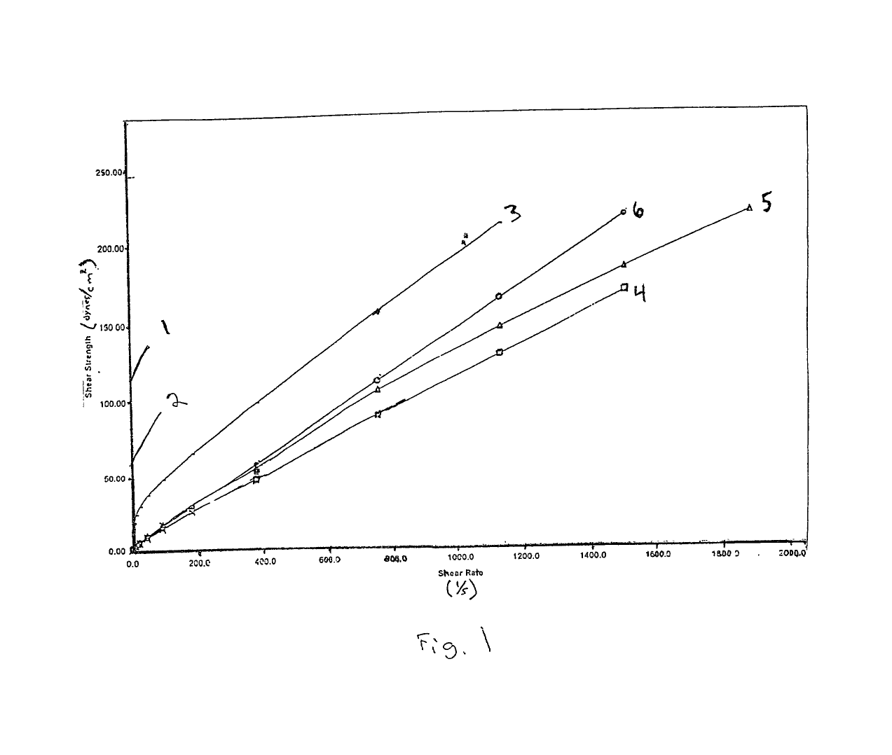

Viscosity measurements were made to characterize the dispersibility of dispersions 1-6. The measurements were made using a viscometer (Brookfield, Model RVDV-3) at room temperature. Shear strength (dynes/cm²) as a function of shear rate (1/s) was measured. The data is plotted in FIG. 1.

Viscosity and yield strength, both of which can be used to characterize particle dispersibility, can be determined from the data. Viscosity is equal to the linear portion of the shear strength/shear rate curves. Yield strength is equal to the y-intercept of the shear strength/shear rate curves. Generally, as the dispersibility of particles in a dispersion increases (for a fixed weight percentage of particles in the dispersion), the viscosity and yield strength decrease.

As shown in FIG. 1, the yield strength and viscosity of dispersions 3-6 are significantly lower than the yield strength of dispersions 1-2. Dispersions 3-6 have a yield strength of 0. Dispersion 5 has the lowest viscosity.

The data illustrates methods of the invention may be used to produce readily dispersible particles. The particles produced according to the methods of the invention have increased dispersibility as compared to particles that are dispersed without the use of a coupling agent (dispersion 1). Also, the particles produced according to the methods of the invention have increased dispersibility as compared to particles that are dispersed using the conventional technique of adding a coupling agent separate from particles (dispersion 2). Furthermore, the concentration of coupling agent may be optimized to produce the desired dispersibility.

Although particular embodiments of the invention have been described in detail for purposes of illustration, various changes and modifications may be made without departing from the scope and spirit of the invention. Accordingly, the invention is not to be limited except by the appended claims.

What is claimed is:

1. A method of processing barium titanate-based particles comprising:
providing a mixture comprising barium titanate-based particles, a coupling agent, and a first fluid;
removing the fluid to form a barium titanate-based particle composition, wherein the coupling agent is attached to surfaces of at least a portion of the barium titanate-based particles; and
dispersing the barium titanate-based particle composition in a second fluid to form a dispersion.

2. The method of claim 1, wherein the second fluid is a non-aqueous fluid.

3. The method of claim 1, wherein the second fluid is a solvent having a precursor of polymeric material dissolved therein.

4. The method of claim 1, further comprising forming a layer from the dispersion.

5. The method of claim 1, further comprising forming a composite structure from the dispersion.

6. The method of claim 5, wherein the composite structure includes a polymer matrix having the barium titanate-based particles distributed therein.

7. The method of claim 1, further comprising adjusting the pH of the mixture to acidic conditions.

8. The method of claim 1, wherein the first fluid comprises alcohol and water.

9. The method of claim 1, wherein the coupling agent is silane-based.

10. The method of claim 1, further comprising producing the barium titanate-based particles in a hydrothermal process prior to providing the mixture.

11. The method of claim 10, further comprising drying the barium titanate-based particles prior to providing the mixture.

12. The method of claim 1, wherein removing the water comprises filtering the dispersion.

13. The method of claim 12, wherein removing the water further comprises drying the barium titanate-based particles after filtering the dispersion.

14. The method of claim 1, further comprising heating the barium titanate-based particles prior to providing the mixture.

15. The method of claim 14, comprising heating the barium titanate-based particles to a maximum temperature of between about 300° C. and about 500° C.

16. The method of claim 1, wherein the mixture is provided by adding barium titanate-based particles to the fluid followed by adding the coupling agent to the fluid.

17. A method of processing barium titanate-based particles comprising removing hydroxyl groups from surfaces of the barium titanate-based particles by heating the barium titanate-based particles to a maximum temperature of greater than about 300° C. and less than about 500° C.

18. The method of claim 17, further comprising hydrothermally producing the barium titanate-based particles prior to removing hydroxyl groups from surfaces of the barium titanate-based particles.

19. The method of claim 18, further comprising drying the hydrothermally-produced barium titanate-based particles prior to removing hydroxyl groups from surfaces of the barium titanate-based particles.

20. The method of claim 17, further comprising cooling the barium titanate-based particles to room temperature.

21. The method of claim 17, further comprising dispersing the barium titanate-based particles in a fluid to form a dispersion after removing hydroxyl groups from surfaces of the barium titanate-based particles.

22. The method of claim 21, wherein the fluid is non-aqueous.

23. The method of claim 21, wherein the fluid is a solvent having a precursor of polymeric material dissolved therein.

24. The method of claim 21, further comprising forming a layer from the dispersion.

25. The method of claim 21, further comprising forming a composite structure from the dispersion.

26. The method of claim 21, wherein the composite structure includes a polymer matrix having the barium titanate-based particles distributed therein.

27. The method of claim 25, wherein forming the composite structure comprises casting the dispersion and evaporating the fluid.

28. The method of claim 17, comprising heating the barium titanate-based particles to a maximum temperature of greater than about 350° C. and less than about 450° C.

29. A particulate composition including a plurality of dried barium titanate-based particles, wherein a coupling agent is attached to surfaces of at least a portion of the barium titanate-based particles.

30. The particulate composition of claim 29, wherein the barium titanate-based particles are hydrothermally-produced.

31. The particulate composition of claim 29, wherein the barium titanate-based particles are substantially spherical.

32. The particulate composition of claim 29, wherein the barium titanate-based particles have an average particle size of less than 0.5 micron.

33. The particulate composition of claim 29, wherein the barium titanate-based particles include a dopant coating layer.

34. The particulate composition of claim 29, wherein the coupling agent is silane-based.
